(19) United States
(12) Patent Application Publication
(10) Pub. No.: US 2007/0015041 A1
(43) Pub. Date: Jan. 18, 2007

(54) Membrane-electrode assemblies

(75) Inventors: Junji Kawai, Tokyo (JP); Toshihiro Ohtsuki, Tokyo (JP); Takanobu Yamamoto, Tokyo (JP); Satoshi Komatsu, Tokyo (JP); Kaoru Fukuda, Saitama (JP); Ryoichiro Takahashi, Saitama (JP); Hiroshi Shinkai, Saitama (JP)

Correspondence Address: ARENT FOX PLLC, 1050 CONNECTICUT AVENUE, N.W., SUITE 400, WASHINGTON, DC, 20036, US

(73) Assignees: JSR CORPORATION; HONDA MOTOR CO., LTD.

(21) Appl. No.: 11/485,618

(22) Filed: Jul. 13, 2006

(30) Foreign Application Priority Data
Jul. 14, 2005 (JP) 2005-205658

(51) Int. Cl. H01M 4/96; H01M 8/10

(52) U.S. Cl. 429/42; 429/44; 429/30; 429/33

(57) ABSTRACT

Membrane-electrode assemblies are provided which have polymer electrolyte membranes capable of maintaining an adequately wet condition even at high temperatures and have superior generating properties. The membrane-electrode assembly includes an ion exchange resin membrane, an anode catalyst layer including catalyst-supported carbon and an ion exchange resin, and a cathode catalyst layer including catalyst-supported carbon and an ion exchange resin, the anode catalyst layer including a binder component of which the ion exchange capacity is higher than that of a binder component in the cathode catalyst layer, and/or the anode catalyst layer including an ion exchange resin layer of which the water content is higher than that of anion exchange resin layer of the cathode catalyst layer.

### FIELD OF THE INVENTION

The present invention relates to membrane-electrode assemblies for fuel cells such as solid polymer fuel cells.

### BACKGROUND OF THE INVENTION

Solid polymer fuel cells are units consisting of an anode and a cathode at which electricity-generating reaction occurs, and a solid polymer electrolyte membrane that is a proton conductor between the anode and cathode. The anode, electrolyte membrane and cathode are sandwiched between separators.

The electrodes are composed of an electrode substrate through which a gas is diffused and electricity is collected, and a catalyst layer at which electrochemical reaction takes place. At the anode, the fuel gas is reacted at the catalyst layer, producing protons and electrons; the electrons are conducted through the electrode substrate, and the protons are transferred through the electrolyte in the electrode and are conducted through the solid polymer electrolyte membrane. At the cathode, the oxidizing gas, the protons from the solid polymer electrolyte membrane, and the electrons from the electrode substrate react together at the catalyst layer to produce water.

Perfluoro electrolytes represented by Nafion® (manufactured by Du Pont Kabushiki Kaisha) and hydrocarbon electrolytes are known as solid polymer electrolyte membranes and electrolytes in electrodes for solid polymer fuel cells. They require water to produce proton conductivity. The solid polymer fuel cells are known to increase generating efficiency when operated at higher temperatures.

At high temperatures, the fuel cell is ultimately operated in a dry condition. Consequently, the water content in the electrolytes is lowered, and electrical conductivity decreases, causing lower output of the fuel cell. When the fuel cell is operated in a wet condition, excess water accumulates in the electrodes and moves to the cathode by accompanying protons when the protons are conducted through the solid polymer electrolyte membrane. In addition, the electrode reaction at the cathode produces water. Thus, flooding occurs if the cathode cannot discharge water sufficiently, resulting in lower output of the fuel cell.

Accordingly, it is necessary that the membrane-electrode assembly maintain an adequately wet condition at high temperatures for the solid polymer fuel cell to achieve high output. The conventional art (for example, JP-A-2000-353528) has been incapable of this.

### SUMMARY OF THE INVENTION

It is an object of the invention to provide membrane-electrode assemblies that have polymer electrolyte membranes capable of maintaining an adequately wet condition even at high temperatures and that have superior generating properties.

The present inventors studied diligently in view of the problems in the conventional art. Consequently, it has been found that a membrane-electrode assembly maintains an adequately wet condition and thereby generating properties are improved when a binder component in an anode catalyst layer has an ion exchange capacity higher than that of a binder component in a cathode catalyst layer, or when an ion exchange resin layer constituting an anode catalyst layer has a water content higher than that of an ion exchange resin layer constituting a cathode catalyst layer.

A membrane-electrode assembly according to the present invention comprises an ion exchange resin membrane, an anode catalyst layer including catalyst-supported carbon and an ion exchange resin, and a cathode catalyst layer including catalyst-supported carbon and an ion exchange resin, the anode catalyst layer including a binder component of which the ion exchange capacity is higher than that of a binder component in the cathode catalyst layer, and/or the anode catalyst layer including an ion exchange resin layer of which the water content is higher than that of an ion exchange resin layer of the cathode catalyst layer.

Preferably, the binder component in the anode catalyst layer has an ion exchange capacity higher than that of the binder component in the cathode catalyst layer, and the ion exchange resin membrane has an ion exchange capacity higher than that of the binder component in the cathode catalyst layer and/or the ion exchange resin membrane has an ion exchange capacity lower than that of the binder component in the anode catalyst layer.

Preferably, at least one of the ion exchange resin constituting the ion exchange resin membrane, the ion exchange resin constituting the anode catalyst layer, and the ion exchange resin constituting the cathode catalyst layer is a block copolymer in which a specific polymer segment (A) with an ion conductive component composed of a sulfonic acid group or a phosphoric acid group, and a specific polymer segment (B) without an ion conductive component are covalently bound.

The membrane-electrode assemblies maintain an adequately wet condition even at high temperatures and thereby enable fuel cells showing superior generating properties.

### PREFERRED EMBODIMENTS OF THE INVENTION

The membrane-electrode assemblies according to the invention will be described in detail below.

The membrane-electrode assemblies have an ion exchange resin membrane, and an anode catalyst layer and a cathode catalyst layer on both surfaces of the resin membrane that contain catalyst-supported carbon and an ion exchange resin.

A first membrane-electrode assembly according to the present invention is characterized in that a binder component in the anode catalyst layer (hereinafter, the anode binder component) has an ion exchange capacity higher than that of a binder component in the cathode catalyst layer (hereinafter, the cathode binder component). Herein, the binder component in the electrode catalyst layer refers to a mixture of the component constituting the electrode catalyst layer except the catalyst-supported carbon and carbon fibers, that is, the ion exchange resin, with optional dispersants and resins having no ion exchange group. The ion exchange capacity is measured with respect to a layer formed of the binder component.

Preferably, the ion exchange capacity of the ion exchange resin membrane is higher than that of the cathode binder component, and is more preferably lower than that of the anode binder component.

The ion exchange resin constituting the ion exchange resin membrane, the anode binder component and the cathode binder component have different ion exchange capacities, and consequently the membrane-electrode assembly can maintain an adequately wet condition, and generating properties are improved. The difference of ion exchange capacity is at least 0.05 meq/g, preferably at least 0.1 meq/g. When the difference of ion exchange capacity is less than this, the above effects are often not obtained.

The ion exchange capacity of the binder components may be adjusted by, although not particularly limited to, controlling the ion exchange capacity of the ion exchange resins constituting the electrode catalyst layers, or controlling the contents of the ion exchange resins in the binder components. The method for controlling the ion exchange capacity of the ion exchange resins will be described later.

A second membrane-electrode assembly according to the present invention is characterized in that the ion exchange resin layer constituting the anode catalyst layer (hereinafter, the anode resin layer) has a water content (wt %) higher than that of the ion exchange resin layer constituting the cathode catalyst layer (hereinafter, the cathode resin layer).

The difference of water content between the anode resin layer and the cathode resin layer is from 5 to 100 wt %, preferably from 20 to 95 wt %, more preferably from 50 to 90 wt %. When the difference of water content is in this range, the membrane-electrode assembly can maintain an adequately wet condition, and generating performance is good. The water content of the anode and cathode resin layers is preferably in the range of 10 to 400 wt %.

Herein, the water content (ΔW) of the anode and cathode resin layers is determined by the following formula:
ΔW=(W₁/W₂−1)×100 (wt %)
wherein W₁ is a weight of the layer soaked in pure water at 95° C. for 24 hours, and W₂ is a weight of the layer after measured for W₁ and dried in vacuum at 120° C. for 2 hours.

The water content of the anode and cathode resin layers may be adjusted by, although not particularly limited to, controlling the ion exchange capacity or molecular weight of the ion exchange resin. The higher the ion exchange capacity, the higher the water content of the electrode resin layer. The higher the molecular weight of the ion exchange resin, the lower the water content of the electrode resin layer.

Preferably, the anode binder component has an ion exchange capacity higher than that of the cathode binder component, and the anode resin layer has a water content higher than that of the cathode resin layer.

[Electrode Catalyst Layers]

The electrode catalyst layers of the membrane-electrode assembly may be formed using an electrode paste composition as described below.

[Electrode Paste Composition]

The electrode paste composition for producing the electrode catalyst layers (anode and cathode catalyst layers) includes catalyst-supported carbon, an ion exchange resin and an organic solvent. Where necessary, the composition may contain other components such as dispersants, carbon fibers, water and resins without an ion exchange group.

<Catalyst-Supported Carbon>

The catalyst used in the electrode paste composition may be platinum or platinum alloy. The use of platinum alloy increases stability and activity of the electrode catalyst. Preferred examples of the platinum alloys include alloys formed between platinum and at least one metal selected from the group consisting of platinum group metals except platinum (ruthenium, rhodium, palladium, osmium and iridium), iron, cobalt, titanium, gold, silver, chromium, manganese, molybdenum, tungsten, aluminum, silicon, rhenium, zinc and tin. The platinum alloys may contain intermetallic compounds of platinum and alloying metals.

The carbon for supporting the catalyst may be carbon blacks such as oil furnace blacks, channel blacks, lamp blacks, thermal blacks and acetylene blacks. These are preferable in terms of electron conductivity and high specific surface area. Natural graphites, pitches, cokes, and synthetic graphites and carbons obtained from organic compounds such as polyacrylonitriles, phenolic resins and furan resins, are also employable.

The oil furnace blacks include VULCAN XC-72, VULCAN P, BLACK PEARLS 880, BLACK PEARLS 1100, BLACK PEARLS 1300, BLACK PEARLS 2000, REGAL 400 (all available from Cabot Corporation), KETJENBLACK EC (available from Lion Corporation), and products Nos. 3150 and 3250 of Mitsubishi Chemical Corporation. The acetylene blacks include DENKA BLACK (available from Denki Kagaku Kogyo K.K.).

The carbon may be in the form of particles or fibers. The amount of the catalyst supported on the carbon is not particularly limited as long as effective catalytic activity is obtained. For example, the amount of the catalyst relative to the carbon is in the range of 0.1 to 9.0 g-metal/g-carbon, preferably 0.25 to 2.4 g-metal/g-carbon.

<Ion Exchange Resin>

The ion exchange resin used in the electrode paste composition is not particularly limited, and perfluoro electrolytes and hydrocarbon electrolytes are employable. From the viewpoints of high heat resistance and high mechanical strength, aromatic polymers containing an ion conductive component are preferable.

The aromatic polymer containing an ion conductive component is preferably a block copolymer in which a polymer segment (A) with an ion conductive component composed of a sulfonic acid group or a phosphoric acid group, and a polymer segment (B) without an ion conductive component are covalently bound. More preferably, the polymer is a polyarylene whose main chain skeleton comprises aromatic rings covalently bound together through binding groups. Particularly preferably, the polymer is a polyarylene with a sulfonic acid group that includes a structural unit represented by Formula (A) (hereinafter, the structural unit (A) or sulfonic acid unit), and a structural unit represented by Formula (B) (hereinafter, the structural unit (B) or hydrophobic unit), as represented by Formula (C).
(Sulfonic Acid Unit)

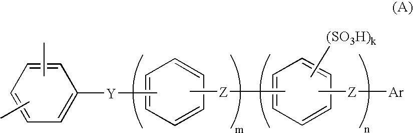

Y is —CO—, —SO₂—, —SO—, —CONH—, —COO—, —(CF₂)ᵢ— (where i is an integer of 1 to 10) or —C(CF₃)₂—, of which —CO— and —SO₂— are preferred.

Z are independently a direct bond, —(CH₂)ⱼ— (where j is an integer of 1 to 10), —C(CH₃)₂—, —O— or —S—, of which a direct bond and —O— are preferred.

Ar is an aromatic group having a substituent represented by —SO₃H, —O(CH₂)ₚSO₃H or —O(CF₂)ₚSO₃H (where p is an integer of 1 to 12). Examples of the aromatic groups include phenyl, naphthyl, anthryl and phenanthryl groups, of which phenyl and naphthyl groups are preferred. Ar should have at least one substituent represented by —SO₃H, —O(CH₂)ₚSO₃H or —O(CF₂)ₚSO₃H, and when Ar is a naphthyl group, it preferably has two or more such substituents.

In the above formula, m is an integer of 0 to 10, preferably 0 to 2; n is an integer of 0 to 10, preferably 0 to 2; and k is an integer of 1 to 4.

Preferred examples of the structural units (A) include structures represented by Formula (A) in which:

(1) m is 0, n is 0, Y is —CO—, and Ar is a phenyl group having a substituent —SO₃H;

(2) m is 1, n is 0, Y is —CO—, Z is —O—, and Ar is a phenyl group having a substituent —SO₃H;

(3) m is 1, n is 1, k is 1, Y is —CO—, Z is —O—, and Ar is a phenyl group having a substituent —SO₃H;

(4) m is 1, n is 0, Y is —CO—, and Ar is a naphthyl group having two substituents —SO₃H; and

(5) m is 1, n is 0, Y is —CO—, Z is —O—, and Ar is a phenyl group having a substituent —O(CH₂)₄SO₃H.
(Hydrophobic Unit)

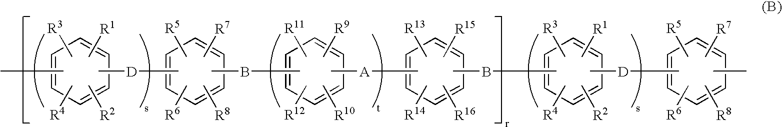

A and D are each a direct bond, —CO—, —SO₂—, —SO—, —CONH—, —COO—, —(CF₂)ᵢ— (where i is an integer of 1 to 10), —(CH₂)ⱼ— (where j is an integer of 1 to 10), —CR′₂—, cyclohexylidene group, fluorenylidene group, —O— or —S—, of which a direct bond, —CO—, —SO₂—, —CR′₂—, cyclohexylidene group, fluorenylidene group and —O— are preferred. R′ is an aliphatic hydrocarbon group, an aromatic hydrocarbon group or a halogenated hydrocarbon group, and examples thereof include methyl, ethyl, propyl, isopropyl, butyl, isobutyl, t-butyl, propyl, octyl, decyl, octadecyl, phenyl and trifluoromethyl groups.

B are independently an oxygen atom or a sulfur atom, preferably an oxygen atom.

R¹ to R¹⁶ are independently each a hydrogen atom, a fluorine atom, an alkyl group, a partially or fully halogenated alkyl group, an allyl group, an aryl group, a nitro group or a nitrile group.

Represented by R¹ to R¹⁶, the alkyl groups include methyl, ethyl, propyl, butyl, amyl, hexyl, cyclohexyl and octyl groups; the halogenated alkyl groups include trifluoromethyl, pentafluoroethyl, perfluoropropyl, perfluorobutyl, perfluoropentyl and perfluorohexyl groups; the allyl groups include propenyl group; and the aryl groups include phenyl and pentafluorophenyl groups.

In the above formula, s and t are each an integer of 0 to 4, and r is an integer of 0 or greater, generally up to 100, and is preferably 1 to 80.

Preferred examples of the structural units (B) include structures represented by Formula (B) in which:

(1) s is 1, t is 1, A is —CR′₂—, cyclohexylidene group or fluorenylidene group, B is an oxygen atom, D is —CO— or —SO₂—, and R¹ to R¹⁶ are each a hydrogen atom or a fluorine atom;

(2) s is 1, t is 0, B is an oxygen atom, D is —CO— or —SO₂—, and R¹ to R¹⁶ are each a hydrogen atom or a fluorine atom; and

(3) s is 0, t is 1, A is —CR′₂—, cyclohexylidene group or fluorenylidene group, B is an oxygen atom, and R¹ to R¹⁶ are each a hydrogen atom, a fluorine atom or a nitrile group.
(Polymer Structure)

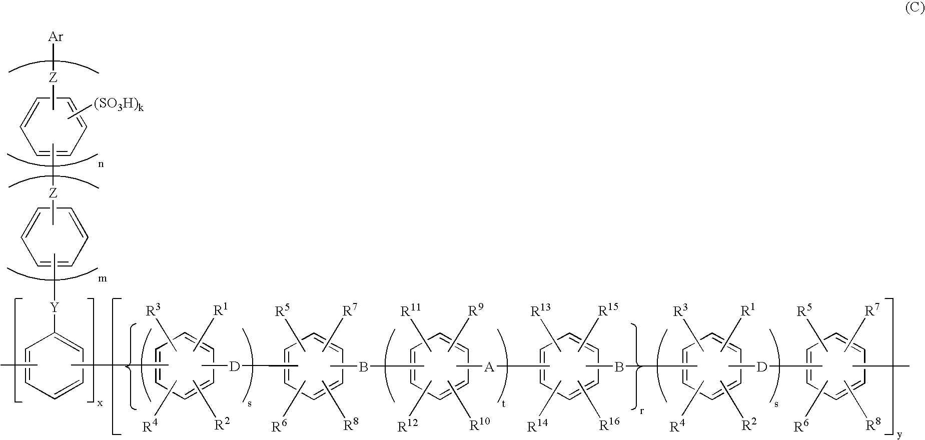

wherein A, B, D, Y, Z, Ar, k, m, n, r, s, t and R¹ to R¹⁶ are as defined in Formulae (A) and (B), and x and y each indicate mol % of which the total (x+y) is 100 mol %.

In the sulfonated polyarylene particularly preferably used in the invention, the content ratio of the structural units (A), that is x, is 0.5 to 99.999 mol %, preferably 10 to 99.99 mol %, and the content ratio of the structural units (B), that is y, is 99.5 to 0.001 mol %, preferably 90 to 0.01 mol %.

(Production of Sulfonated Polyarylene)

The sulfonated polyarylene may be produced by methods A, B and C described below.

(Method A)

A monomer with a sulfonate group that is capable of forming the structural unit (A), and a monomer or oligomer capable of forming the structural unit (B) are copolymerized to give a polyarylene with a sulfonate group. The sulfonate group is de-esterified into a sulfonic acid group. This method is specifically described in JP-A-2004-137444.

(Method B)

A monomer having a skeleton represented by Formula (A) except that the monomer has no sulfonic acid group or sulfonate group, and a monomer or oligomer capable of forming the structural unit (B) are copolymerized. The copolymer obtained is sulfonated with a sulfonating agent. This method is specifically described in JP-A-2001-342241.

(Method C)

This method is useful when Ar in Formula (A) is an aromatic group having a substituent —O(CH₂)ₚSO₃H or —O(CF₂)ₚSO₃H. A precursor monomer capable of forming the structural unit (A), and a monomer or oligomer capable of forming the structural unit (B) are copolymerized. Subsequently, an alkylsulfonic acid or a fluorine-substituted alkylsulfonic acid is introduced into the copolymer. This method is specifically described in JP-A-2005-60625.

Referring to the method A, examples of the monomers with a sulfonate group that are capable of forming the structural units (A) include sulfonates described in JP-A-2004-137444, JP-A-2004-345997 and JP-A-2004-346163.

Referring to the method B, examples of the monomers without a sulfonic acid group or a sulfonate group that are capable of forming the structural units (A) include dihalides described in JP-A-2001-342241 and JP-A-2002-293889.

Referring to the method C, examples of the precursor monomers capable of forming the structural units (A) include dihalides described in JP-A-2005-36125.

Referring to the methods A to C, examples of the monomers or oligomers capable of forming the structural units (B) are as follows.

When r in Formula (B) is 0, examples of the monomers or oligomers include 4,4′-dichlorobenzophenone, 4,4′-dichlorobenzanilide, 2,2-bis(4-chlorophenyl)difluoromethane, 2,2-bis(4-chlorophenyl)-1,1,1,3,3,3-hexafluoropropane, 4-chlorobenzoic acid-4-chlorophenyl ester, bis(4-chlorophenyl)sulfoxide, bis(4-chlorophenyl)sulfone, 2,6-dichlorobenzonitrile, and derivatives of the above compounds in which the chlorine atom is replaced by a bromine or an iodine atom.

When r in Formula (B) is 1, examples of the monomers or oligomers include compounds as described in JP-A-2003-113136.

When r in Formula (B) is equal to or greater than 2, examples of the monomers or oligomers include compounds as described in JP-A-2004-137444, JP-A-2004-244517, JP-A-2004-346164, and Japanese Patent Application Nos. 2003-348523, 2003-348524, 2004-211739 and 2004-211740.

The synthesis of the polyarylene having a sulfonic acid group should start with copolymerization of the monomer for the structural unit (A) and the monomer or oligomer for the structural unit (B) in the presence of a catalyst, producing a precursor polyarylene. The catalyst used in the copolymerization is a catalyst system containing a transition metal compound. This catalyst system essentially contains (i) a transition metal salt and a compound as a ligand, or a transition metal complex (including a copper salt) to which a ligand is coordinated, and (ii) a reducing agent. A “salt” may be added to increase the polymerization rate. Specific examples of the catalyst components, amounts of the components, reaction solvents, concentrations, temperatures, reaction time and other polymerization conditions are described in JP-A-2001-342241.

The precursor polyarylene is converted into a polyarylene having a sulfonic acid group, and thereby the sulfonated polyarylene used in the invention is obtained. For example, the above conversion is possible by the following three methods.

(Method a)

The precursor obtained by the method A, that is, the polyarylene having a sulfonate group is de-esterified by a method described in JP-A-2004-137444.

(Method b)

The precursor polyarylene obtained by the method B is sulfonated by a method described in JP-A-2001-342241.

(Method c)

The precursor polyarylene obtained by the method C is alkylsulfonated by a method described in JP-A-2005-60625.

The sulfonated polyarylene represented by Formula (C) that is produced as described above generally has an ion exchange capacity of 0.3 to 5 meq/g, preferably 0.5 to 3 meq/g, more preferably 0.8 to 2.8 meq/g. Any ion exchange capacity less than this tends to result in lower proton conductivity and lower generating performance. When the ion exchange capacity exceeds the above range, the water resistance is often drastically deteriorated.

The ion exchange capacity may be controlled by changing the types, amounts and combinations of the precursor monomer for the structural unit (A) and the monomer or oligomer for the structural unit (B). Specifically, the ion exchange capacity is preferably controlled by changing the amounts in which the monomer for the structural unit (A) and the monomer or oligomer for the structural unit (B) are used. By controlling the ion exchange capacity in this manner, the ion exchange resin can produce suitable anode and cathode catalyst layers.

The polyarylene having a sulfonic acid group has a weight-average molecular weight in terms of polystyrene of 10,000 to 1,000,000, preferably 20,000 to 800,000 as measured by gel permeation chromatography (GPC). The molecular weight maybe controlled by, for example, adding 4-chlorobenzophenone as polymerization terminator. By controlling the molecular weight in this manner, the ion exchange resin can produce suitable anode and cathode catalyst layers.

<Organic Solvent>

Examples of the organic solvents for use in the electrode paste composition include hydrocarbon solvents such as ethanol, n-propyl alcohol, 2-propanol, 2-methyl-2-propanol, 2-butanol, n-butyl alcohol, 2-methyl-1-propanol, 1-pentanol, 2-pentanol, 3-pentanol, 2-methyl-1-butanol, 3-methyl-1-butanol, 2-methyl-2-butanol, 3-methyl-2-butanol, 2,2-dimethyl-1-propanol, cyclohexanol, 1-hexanol, 2-methyl-1-pentanol, 2-methyl-2-pentanol, 4-methyl-2-pentanol, 2-ethyl-1-butanol, 1-methylcyclohexanol, 2-methylcyclohexanol, 3-methylcyclohexanol, 4-methylcyclohexanol, 1-octanol, 2-octanol, 2-ethyl-1-hexanol, dioxane, butyl ether, phenyl ether, isopentyl ether, 1,2-dimethoxyethane, diethoxyethane, bis(2-methoxyethyl) ether, bis(2-ethoxyethyl) ether, cineol, benzyl ethyl ether, anisole, phenetole, acetal, methyl ethyl ketone, 2-pentanone, 3-pentanone, cyclopentanone, cyclohexanone, 2-hexanone, 4-methyl-2-pentanone, 2-heptanone, 2,4-dimethyl-3-pentanone, 2-octanone, γ-butyrolactone, n-butyl acetate, isobutyl acetate, sec-butyl acetate, pentyl acetate, isopentyl acetate, 3-methoxybutyl acetate, methyl butyrate, ethyl butyrate, methyl lactate, ethyl lactate, butyl lactate, 2-methoxyethanol, 2-ethoxyethanol, 2-(methoxymethoxy)ethanol, 2-isopropoxyethanol, 1-methoxy-2-propanol, 1-ethoxy-2-propanol, dimethylsulfoxide, N-methylformamide, N,N-dimethylformamide, N,N-diethylformamide, N,N-dimethylacetamide, N-methyl-2-pyrrolidone (NMP), tetramethylurea, toluene, xylene, heptane and octane; and polyhydric alcohol solvents such as ethylene glycol, propylene glycol and glycerol.

The organic solvents maybe used singly or in combination of two or more kinds. From the viewpoint of solubility of the ion exchange resin, the solvent preferably contains a water-soluble aprotic dipolar organic solvent, more preferably at least 10% of a water-soluble aprotic dipolar organic solvent.

Examples of the water-soluble aprotic dipolar organic solvents include dimethylacetamide, dimethylformamide, N-methyl-2-pyrrolidone (NMP), dimethylsulfoxide, tetramethylurea, 1,3-dimethyl-2-imidazolidinone and γ-butyrolactone.

<Dispersant>

The electrode paste composition may contain a dispersant as required. Examples of the dispersants include anionic surfactants, cationic surfactants, amphoteric surfactants and nonionic surfactants.

The anionic surfactants include N-methyltauro oleic acid, potassium oleate/diethanolamine salts, triethanolamine alkylether sulfates, triethanolamine polyoxyethylene alkylether sulfates, amine salts of specially modified polyetherester acids, amine salts of higher fatty acid derivatives, amine salts of specially modified polyester acids, amine salts of high molecular weight polyetherester acids, amine salts of specially modified phosphates, amidoamine salts of high molecular weight polyester acids, amidoamine salts of special fatty acid derivatives, alkylamine salts of higher fatty acids, amidoamine salts of high molecular weight polycarboxylic acids, sodium laurate, sodium stearate, sodium oleate, sodium lauryl sulfate, sodium cetyl sulfate, sodium stearyl sulfate, sodium oleyl sulfate, lauryl ether sulfate, sodium alkylbenzene sulfonates, oil-soluble alkylbenzene sulfonates, α-olefin sulfonates, disodium higher alcohol monophosphates, disodium higher alcohol diphosphates and zinc dialkyldithiophosphate.

The cationic surfactants include benzyldimethyl{2-[2-(P-1,1,3,3-tetramethylbutylphenoxy)ethoxy]ethyl}ammonium chloride, octadecylamine acetate, tetradecylamine acetate, octadecyltrimethylammonium chloride, tallowtrimethylammonium chloride, dodecyltrimethylammonium chloride, cocotrimethylammonium chloride, hexadecyltrimethylammonium chloride, behenyltrimethylammonium chloride, cocodimethylbenzylammonium chloride, tetradecyldimethylbenzylammonium chloride, octadecyldimethylbenzylammonium chloride, dioleyldimethylammonium chloride, quaternary salt of 1-hydroxyethyl-2-tallowimidazoline, 2-heptadecenyl-hydroxyethylimidazoline, stearamidoethyldiethylamine acetate, stearamidoethyldiethylamine hydrochloride, triethanolamine monostearate formate, alkylpyridium salts, ethylene oxide adducts with higher alkylamines, polyacrylamide amine salts, modified polyacrylamide amine salts and perfluoroalkyl quaternary ammonium iodides.

The amphoteric surfactants include dimethylcocobetaine, dimethyllaurylbetaine, laurylaminoethylglycinesodium, sodium laurylaminopropionate, stearyldimethylbetaine, lauryldihydroxyethylbetaine, amidobetaine, imidazoliniumbetaine, lecithin, sodium 3-[ω-fluoroalkanoyl-N-ethylamino]-1-propanesulfonate and N-[3-(perfluorooctanesulfonamido)propyl]-N,N-dimethyl-N-carboxymethyleneammoniumbetaine.

The nonionic surfactants include cocofatty acid diethanolamide (1:2 type), cocofatty acid diethanolamide (1:1 type), tallow diethanolamide (1:2 type), tallow diethanolamide (1:1 type), oleic acid diethanolamide (1:1 type), hydroxyethyl laurylamine, polyethylene glycol laurylamine, polyethylene glycol cocoamine, polyethylene glycol stearylamine, polyethylene glycol tallowamine, polyethylene glycol tallowpropylenediamine, polyethylene glycol dioleylamine, dimethyllaurylamine oxide, dimethylstearylamine oxide, dihydroxyethyllaurylamine oxide, perfluoroalkylamine oxides, polyvinylpyrrolidone, ethylene oxide adducts of higher alcohols, ethylene oxide adducts of alkylphenols, ethylene oxide adducts of fatty acids, ethylene oxide adducts of polypropylene glycol, fatty acid esters of glycerol, fatty acid esters of pentaerythritol, fatty acid esters of sorbitol, fatty acid esters of sorbitan and fatty acid esters of sugar.

The dispersants may be used singly or in combination of two or more kinds. Of the above surfactants, the surfactants having basic groups are preferred, and the anionic and cationic surfactants are more preferred, and the surfactants ranging in molecular weight from 5,000 to 30,000 are even more preferred. The dispersants give the electrode paste composition good storage stability and fluidity, and also enable excellent application properties.

<Carbon Fibers>

The electrode paste composition may contain carbon fibers as required. Examples of the carbon fibers include rayon carbon fibers, PAN carbon fibers, Ligunin-Poval carbon fibers, pitch carbon fibers and vapor grown carbon fibers. Of these, the vapor grown carbon fibers are preferable.

The electrode paste composition containing the carbon fibers can give electrode catalyst layers having larger pore volumes. Consequently, the diffusibility of the fuel and oxygen gases is enhanced and the flooding of water produced and other similar problems are prevented, leading to improved generating performance.

<Water>

The electrode paste composition may contain water as required. Addition of water is effective to reduce the heat generated in the preparation of the electrode paste composition.

<Resin Without Ion Exchange Group>

The electrode paste composition may contain a resin without an ion exchange group as required. Such resins are not particularly limited as long as they are dissolved or dispersed in the organic solvents. Resins having high water repellency are preferred. Examples of the resins include fluorocopolymers, silane-coupling agents, silicone resins, waxes and polyphosphazenes, with the fluorocopolymers being preferred.

The fluorocopolymers are not particularly limited as long as they are dissolved or dispersed in the organic solvents. Examples thereof include vinylidene fluoride copolymers, perfluorocarbon polymers having an aliphatic ring structure in the molecule, copolymers of fluoroolefins and hydrocarbon olefins, and copolymers of fluoroacrylates and acrylate and/or methacrylate. The resins without an ion exchange group enable the catalyst layers to maintain an adequately wet condition.

<Composition>

The electrode catalyst layers of the membrane-electrode assembly preferably contain: 20 to 90 wt %, preferably 40 to 85 wt % the catalyst-supported carbon; 5 to 60 wt %, preferably 10 to 50 wt % the ion exchange resin; 0 to 10 wt %, preferably 0 to 3 wt % the optional dispersant; 0 to 20 wt %, preferably 1 to 10 wt % the optional carbon fibers; and 0 to 20 wt %, preferably 1 to 10 wt % the optional resin without an ion exchange group (the total being 100 wt %).

When the amount of the catalyst-supported carbon is less than described above, the electrode reactivity is often lowered. When it exceeds the above range, the proton conduction efficiency can be lowered, and the electrode catalyst layers tend to have insufficient pore volumes for generating performance. When the amount of the ion exchange resin is less than described above, the proton conductivity tends to be lowered and the ion exchange resin cannot work as a binder, often resulting in failure of electrode formation. When the ion exchange resin is used in amounts above the aforesaid range, the pore volume in the electrode tends to decrease.

The above amount of the dispersant leads to the electrode paste showing excellent storage stability, and consequently the electrode catalyst layers have good dispersion properties. The amount of the carbon fibers within the aforesaid range ensures appropriate pore volumes and good water discharge, leading to improved output of power generation. When the amount of the resin without an ion exchange group is within the above range, the catalyst layers maintain an adequately wet condition, leading to improved output of power generation.

Accordingly, the electrode paste composition contains the catalyst-supported carbon, ion exchange resin, dispersant, carbon fibers, and resin without an ion exchange group in amounts such that the electrode catalyst layers have the above composition. The amount of the organic solvent used in preparing the electrode catalyst paste composition is in the range of 5 to 95 wt %, preferably 15 to 90 wt %, and that of water optionally used is in the range of 0 to 70 wt %, preferably 2 to 30 wt %, based on 100 wt % of the paste composition.

When the organic solvent is used in the above amount, the resultant composition becomes a paste and is easily handled. The above amount of water is effective to reduce the heat generated in the preparation of the catalyst paste.

<Preparation of Electrode Paste Composition>

The electrode paste composition may be produced by mixing the components in the specified amounts and kneading the mixture by a common method. The addition sequence of the components is not particularly limited. For example, and preferably, all the components may be mixed together and stirred for a given time. Also preferably, the components except the dispersant may be mixed together and stirred for a given time, and the dispersant may be added as required followed by stirring for a given time. The amount of the organic solvent may be changed as required to control the viscosity of the composition.

[Production of Electrode Catalyst Layers]

The electrode catalyst layers of the membrane-electrode assembly may be produced by applying the electrode paste composition to an electrode substrate, a transfer substrate or the ion exchange resin membrane which will be described below, followed by drying.

The application methods include brushing, brush coating, bar coating, knife coating, doctor blade coating, screen printing and spray coating.

The electrode substrates are not particularly limited. Examples thereof include electrode substrates commonly used in fuel cells, such as porous conductive sheets composed mainly of conductive substances. Examples of the transfer substrates include polytetrafluoroethylene (PTFE) sheets, and glass plates and metal plates that are surface treated with releasing agents.

Examples of the conductive substances include calcined polyacrylonitriles, calcined pitches, carbon materials such as graphites and expanded graphites, stainless steel, molybdenum and titanium. The conductive substances may have the form of fibers or particles, but are not limited thereto. Fibrous conductive inorganic substances (inorganic conductive fibers), particularly carbon fibers, are preferable.

The porous conductive sheets made of such inorganic conductive fibers may be woven or nonwoven fabrics. The woven fabrics are not particularly limited and include plain fabrics, twill fabrics, satin fabrics, designed fabrics and figured fabrics. The nonwoven fabrics are not particularly limited and include nonwoven fabrics obtained by papermaking methods, needle punched nonwoven fabrics, spunbonded nonwoven fabrics, water jet punched nonwoven fabrics and meltblown nonwoven fabrics. Knitted fabrics of inorganic conductive fibers are also usable as the porous conductive sheets.

These fabrics, particularly when composed of carbon fibers, are preferably woven fabrics obtained through carbonization or graphitization of plain fabrics of flame-resistant spun yarns, or nonwoven fabrics obtained through carbonization or graphitization of needle punched or water jet punched nonwoven fabrics of flame-resistant yarns, or nonwoven mats obtained by papermaking technique with flame-resistant yarns, or carbonized or graphitized yarns. For example, carbon paper TGP series and SO series manufactured by Toray Industries, Inc., and carbon cloths manufactured by E-TEK may be preferably used.

It is preferable that the porous conductive sheets contain conductive particles such as carbon blacks, or conductive fibers such as carbon fibers as auxiliaries to achieve higher conductivity.

The thickness of the coating (i.e., the electrode catalyst layer) is not particularly limited but is preferably such that the electrode catalyst layer contains the metal catalyst in an amount per unit are of 0.05 to 4.0 mg/cm², preferably 0.1 to 2.0 mg/cm². This amount of the catalyst achieves sufficient catalytic activity and protons can be produced efficiently.

After the electrode paste composition is applied, the solvent is removed by drying at 20 to 180° C., preferably 50 to 160° C., for 5 to 180 minutes, preferably 30 to 120 minutes. Where necessary, the solvent may be removed by soaking the coating in water at a water temperature of 5 to 120° C., preferably 15 to 95° C., for 1 minute to 72 hours, preferably 5 minutes to 48 hours.

The electrode catalyst layers thus produced have a pore volume of 0.1 to 3.0 ml/g-(electrode catalyst layer), preferably 0.2 to 2.0 ml/g-(electrode catalyst layer). When the pore volume exceeds this range, mechanical properties tend to be lowered, and electron and proton conducting paths are disconnected, often resulting in lowered generating performance. When the pore volume is less than described, water discharge is bad and generating performance is often lowered.

[Ion Exchange Resin Membrane]

The ion exchange resin membrane of the membrane-electrode assembly is not particularly limited, and known ion exchange resin membranes (proton conductive membranes) are employable. The ion exchange resin of which the ion exchange resin membrane is formed is preferably the same as that used in the electrode paste composition. The ion exchange resin desirably has an ion exchange capacity of 0.3 to 5.0 meq/g, preferably 0.5 to 4.0 meq/g.

The ion exchange resin membrane may be formed by a casting method in which a composition containing the ion exchange resin and an organic solvent is cast over a substrate to form a film. The organic solvents used herein may be similar to those described with respect to the electrode paste composition. In addition to the ion exchange resin and organic solvent, the composition may contain inorganic acids such as sulfuric acid and phosphoric acid, organic acids including carboxylic acids, and appropriate amounts of water.

Although the polymer concentration in the composition depends on the molecular weight of the ion exchange resin, it is generally from 5 to 40 wt %, preferably from 7 to 25 wt %. Any polymer concentration less than this will cause difficulties in producing the membrane in large thickness and tends to result in easy occurrence of pinholes. When the polymer concentration exceeds the above range, the solution viscosity becomes so high that the membrane production will be difficult, and the membrane obtained often has low surface smoothness.

The viscosity of the solution of the composition may vary depending on the copolymer's molecular weight and polymer concentration. Generally, it ranges from 2,000 to 100,000 mPa·s, preferably from 3,000 to 50,000 mPa·s. When the solution viscosity is less than this, the solution will have too high a fluidity and can spill out of the substrate during the membrane production. Any viscosity exceeding this range is so high that the solution cannot be extruded through a die and the casting for the membrane production is often difficult.

The composition may be prepared by mixing the aforesaid components in a predetermined ratio by conventional methods, for example by mixing with a mixer such as a wave rotor, a homogenizer, a disperser, a paint conditioner or a ball mill.

The substrate used herein is not particularly limited as long as it is commonly used in the solution casting methods. For example, plastic substrates and metal substrates may be used, and thermoplastic resin substrates such as polyethyleneterephthalate (PET) films may be preferably used. The electrode catalyst layer may be used as substrate.

The film produced by the casting method is dried at 30 to 160° C., preferably 50 to 150° C., for 3 to 180 minutes, preferably 5 to 120 minutes. Consequently, an ion exchange resin membrane (proton conductive membrane) is obtained. The dry thickness is generally from 10 to 100 μm, preferably 20 to 80 μm. When the solvent remains in the membrane after the drying, it may be removed by extraction with water as required. The ion exchange resin membrane may contain, in addition to the ion exchange resin, inorganic acids such as sulfuric acid and phosphoric acid, organic acids including carboxylic acids, and appropriate amounts of water.

[Production of Membrane-Electrode Assembly]

The membrane-electrode assembly according to the present invention may be produced by providing the electrode catalyst layers on both surfaces of the ion exchange resin membrane.

The electrode catalyst layers may be provided on both surfaces of the ion exchange resin membrane by the following methods.

The electrode paste composition is directly applied to the ion exchange resin membrane followed by drying.

The electrode paste composition is applied to the electrode substrate followed by drying to produce an electrode having an electrode catalyst layer; and the electrodes and the ion exchange resin membrane are bonded together by hot pressing or the like such that the electrode catalyst layers contact the ion exchange resin membrane.

The electrode paste composition is applied to a substrate (transfer substrate) to produce an electrode catalyst layer; and the electrode catalyst layer is transferred on the ion exchange resin membrane or electrode substrate.

The hot pressing is performed at a temperature of 30 to 200° C., preferably 40 to 180° C., at a pressure of 5 to 300 kg/cm², preferably 10 to 180 kg/cm², and for 30 seconds to 60 minutes, preferably 1 to 30 minutes. The hot pressing under these conditions provides good bonding between the electrode layers and the membrane.

When a gas diffusion layer such as carbon paper is bonded on the electrode catalyst layer, they may be bonded together by hot pressing under the above conditions.

### EXAMPLES

The present invention will be described in greater detail by examples below, but it should be construed that the invention is in no way limited to such examples. The ion exchange capacity, molecular weight and water content were measured as follows.

1. Ion Exchange Capacity

(Ion Exchange Resin Membrane)

A predetermined amount of each ion exchange resin membrane was weighed out. The membrane was soaked in water and was titrated using an NaOH standard solution and an indicator consisted of phenolphthalein dissolved in a THF/water mixed solvent. The ion exchange capacity was determined from the point of neutralization.

(Binder Component)

Films were prepared from binder components for electrode catalyst layers. A predetermined amount of each film was weighed out. The film was soaked in water and was titrated using an NaOH standard solution and an indicator consisted of phenolphthalein dissolved in a THF/water mixed solvent. The ion exchange capacity was determined from the point of neutralization.

2. Molecular Weight

A polyarylene having no sulfonic acid group was dissolved in tetrahydrofuran (THF) as solvent, and its molecular weight in terms of polystyrene was measured by GPC. A polyarylene having a sulfonic acid group was measured for molecular weight in terms of polystyrene by GPC using N-methyl-2-pyrrolidone (NMP) containing lithium bromide and phosphoric acid as an eluting solution.

3. Water Content

A 2×3 cm piece was cut out from each film consist of ion exchange resin, and was soaked in pure water at 95° C. for 24 hours. The piece was taken out, and a weight W₁ was measured. The piece was dried in vacuum at 120° C. for 2 hours, and a weight W₂ was measured. The water content (ΔW) was determined by the following formula:
ΔW=(W₁/W₂−1)×100 (wt %)

### Synthetic Example 1

(1) Synthesis of Hydrophobic Units

A 1-L three-necked flask equipped with a stirrer, a thermometer, a Dean-Stark tube, a nitrogen inlet tube and a cooling tube was charged with 29.8 g (104 mmol) of 4,4′-dichlorodiphenylsulfone, 37.4 g (111 mmol) of 2,2-bis(4-hydroxyphenyl)-1,1,1,3,3,3-hexafluoropropane, and 20.0 g (145 mmol) of potassium carbonate. The flask was purged with nitrogen, and 168 ml of sulfolane and 84 ml of toluene were added, followed by stirring. The reaction liquid was heated under reflux at 150° C. in an oil bath. Water resulting from the reaction was trapped in the Dean-Stark tube. Water almost ceased to occur after 3 hours, and the toluene was removed outside the system through the Dean-Stark tube. The reaction temperature was slowly raised to 200° C. and stirring was performed for 5 hours. Thereafter, 7.5 g (30 mmol) of 4,4′-dichlorobenzophenone was added to carry out reaction for another 8 hours. The reaction liquid was allowed to cool, and was diluted with 100 ml of toluene. The reaction liquid was filtered to remove insoluble inorganic salts, and the filtrate was poured into 2 L of methanol to precipitate the product. The precipitated product was filtered off, dried and dissolved in 250 ml of tetrahydrofuran. The resultant solution was poured into 2 L of methanol to perform reprecipitation. The precipitated white powder was filtered off and was dried to yield 56 g of an objective compound. GPC resulted in a number-average molecular weight (Mn) of 10,500. The compound was identified to be an oligomer represented by Formula (I) below: 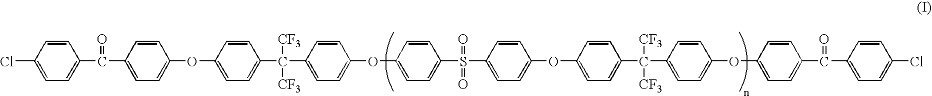
(2) Synthesis of Sulfonated Polyarylene

A 1-L three-necked flask equipped with a stirrer, a thermometer and a nitrogen inlet tube was charged with 135.5 g (338 mmol) of neopentyl 3-(2,5-dichlorobenzoyl) benzenesulfonate, 44.5 g (4.2 mmol) of the oligomer (Mn: 10,500) obtained in (1), 6.71 g (10.3 mmol) of bis(triphenylphosphine)nickel dichloride, 1.54 g (10.3 mmol) of sodium iodide, 35.9 g (136 mmol) of triphenylphosphine, and 53.7 g (820 mmol) of zinc. The flask was purged with dry nitrogen, and 430 ml of N,N-dimethylacetamide (DMAc) was added. The mixture was stirred for 3 hours while maintaining the reaction temperature at 80° C. The reaction liquid was diluted with 730 ml of DMAc, and insolubles were filtered.

The solution obtained was introduced into a 2-L three-necked flask equipped with a stirrer, a thermometer and a nitrogen inlet tube, and was heated to 115° C. with stirring. Subsequently, 44 g (506 mmol) of lithium bromide was added. After the mixture had been stirred for 7 hours, it was poured into 5 L of aceton to precipitate the product. The product was washed sequentially with 1N hydrochloric acid and with pure water, and was dried to give 124 g of an objective polymer. The weight-average molecular weight (Mw) of the polymer was 170,000. The polymer was assumed to be a sulfonated polymer represented by Formula (II) (hereinafter, the polymer (II)). The polymer (II) had an ion exchange capacity of 2.3 meq/g.

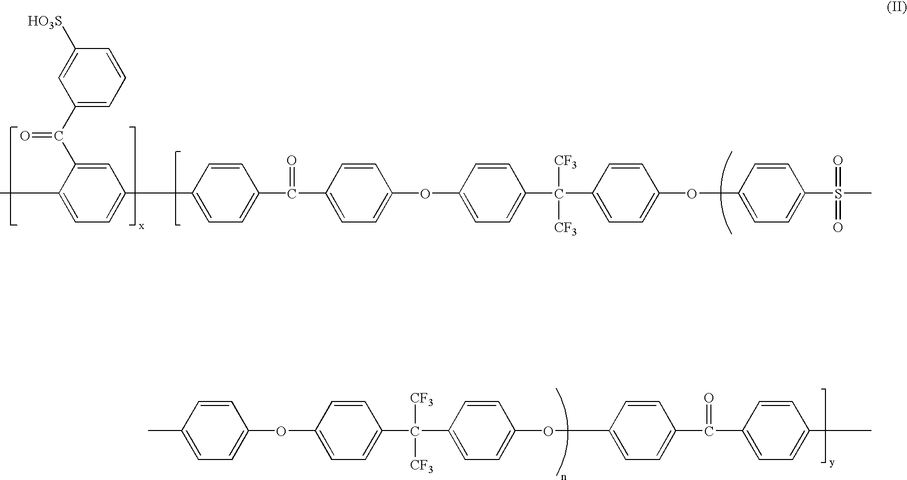

### Example 1

<Preparation of Anode Paste>

A 50-ml plastic bottle was charged with 25 g of zirconia balls 10 mm in diameter (YTZ balls manufactured by Nikkato Corporation), 1.53 g of platinum-supported carbon particles (manufactured by Tanaka Kikinzoku Kogyo, Pt content: 48 wt %), 0.88 g of distilled water, 12.47 g of NMP, and 4.59 g of a 15 wt % NMP solution of a polymer which had a structure similar to that of the polymer (II) of Synthetic Example 1 and had an ion exchange capacity of 2.4 meq/g. The materials were stirred with a paint shaker for 60 minutes to give an anode paste A.

<Preparation of Cathode Paste>

A 50-ml plastic bottle was charged with 25 g of zirconia balls 10 mm in diameter (YTZ balls manufactured by Nikkato Corporation), 1.53 g of platinum-supported carbon particles (manufactured by Tanaka Kikinzoku Kogyo, Pt content: 48 wt %), 0.88 g of distilled water, 12.47 g of NMP, 0.1 g of vapor grown carbon fiber (VGCF manufactured by Showa Denko K.K.), and 4.59 g of a 15 wt % NMP solution of a polymer which had a structure similar to that of the polymer (II) of Synthetic Example 1 and had an ion exchange capacity of 2.2 meq/g. The materials were stirred with a paint shaker for 60 minutes to give a cathode paste B.

<Production of Electrodes>

The anode paste A was applied to water-repellent carbon paper (manufactured by Toray Industries, Inc.) with a doctor blade, and the coating was dried at 120° C. for 60 minutes to produce an anode A containing 0.2 mg/cm² of platinum. The cathode paste B was applied to water-repellent carbon paper (manufactured by Toray Industries, Inc.) with a doctor blade, and the coating was dried at 120° C. for 60 minutes to produce a cathode B containing 0.5 mg/cm² of platinum.

<Fabrication of Fuel Cell>

An ion exchange resin membrane 50 μm in thickness was prepared from the polymer (II) of Synthetic Example 1. The membrane was sandwiched between the anode A and the cathode B such that the electrode catalyst layers contacted the membrane. The unit was hot pressed at 100 kg/cm² and 160° C. for 15 minutes, and a membrane-electrode assembly was prepared. The membrane-electrode assembly was sandwiched between two titanium collectors, and heaters were provided outside each collector. Consequently, a fuel cell sample having an effective area of 25 cm² was fabricated.

### Example 2

<Preparation of Anode Paste>

An anode paste C was prepared in the same manner as in Example 1, except using a polymer which had a structure similar to that of the polymer (II) of Synthetic Example 1 and had an ion exchange capacity of 2.2 meq/g.

<Preparation of Cathode Paste>

A cathode paste D was prepared in the same manner as in Example 1, except using a polymer which had a structure similar to that of the polymer (II) of Synthetic Example 1 and had an ion exchange capacity of 2.1 meq/g.

<Production of Electrodes>

An anode C and a cathode D were produced in the same manner as in Example 1, except using the anode paste C and the cathode paste D.

<Fabrication of Fuel Cell>

A fuel cell sample was fabricated in the same manner as in Example 1, except using the anode C and the cathode D.

### Comparative Example 1

<Preparation of Cathode Paste>

A cathode paste E was prepared in the same manner as in Example 1, except using a polymer which had a structure similar to that of the polymer (II) of Synthetic Example 1 and had an ion exchange capacity of 2.4 meq/g.

<Production of Electrode>

A cathode E was produced in the same manner as in Example 1, except using the cathode paste E.

<Fabrication of Fuel Cell>

A fuel cell sample was fabricated in the same manner as in Example 1, except using the cathode E obtained above and the anode C obtained in Example 2.

### Comparative Example 2

<Preparation of Anode Paste>

An anode paste F was prepared in the same manner as in Example 1, except using a polymer which had a structure similar to that of the polymer (II) of Synthetic Example 1 and had an ion exchange capacity of 2.1 meq/g.

<Production of Electrode>

An anode F was produced in the same manner as in Example 1, except using the anode paste F.

<Fabrication of Fuel Cell>

A fuel cell sample was fabricated in the same manner as in Example 1, except using the anode F obtained above and the cathode B obtained in Example 1.

[Evaluation]

Hydrogen and air were supplied at a constant back pressure of 0.2 MPa to the fuel cell samples of Examples 1-2 and Comparative Examples 1-2, at 80° C. and 100% RH. The voltage between the terminals was measured at current density of 0.1 A/cm² and 1.0 A/cm². The results are shown in Table 1.

TABLE 1

| | | | | Comp. | Comp. |
|---|---|---|---|---|---|
| | | Ex. 1 | Ex. 2 | Ex. 1 | Ex. 2 |
| Ion | Anode | 2.4 | 2.2 | 2.2 | 2.1 |
| exchange | Ion exchange | 2.3 | 2.3 | 2.3 | 2.3 |
| capacity | resin membrane | | | | |
| (meq/g) | Cathode | 2.2 | 2.1 | 2.4 | 2.2 |
| Voltage | 0.1 A/cm² | 0.83 | 0.80 | 0.80 | 0.78 |
| between | 1.0 A/cm² | 0.60 | 0.58 | 0.48 | 0.54 |
| terminals | | | | | |
| (V) | | | | | |

In Examples 1 and 2, the sulfonated polymers of the anodes surpassed the sulfonated polymers of the cathodes in ion exchange capacity. In Comparative Examples 1 and 2, the sulfonated polymers of the anodes had lower ion exchange capacity than the sulfonated polymers of the cathodes. As shown in Table 1, Examples 1 and 2 resulted in superior performance of the fuel cells to Comparative Examples 1 and 2.

### Synthetic Example 2

A 1000-ml three-necked flask equipped with a stirring blade, a thermometer and a nitrogen inlet tube was charged with 90.3 g (225 mmol) of neopentyl 3-(2,5-dichlorobenzoyl) benzenesulfonate, 69.1 g (275 mmol) of 2,5-dichlorobenzophenone, 1.08 g (5 mmol) of 4-chlorobenzophenone, 9.81 g (15 mmol) of bis(triphenylphosphine)nickel dichloride, 2.25 g (15 mmol) of sodium iodide, 52.5 g (200 mmol) of triphenylphosphine, and 78.4 g (1200 mmol) of zinc. Inside the flask was dried in vacuum for 2 hours, and the flask was purged with dry nitrogen. 373 ml of dehydrated dimethylacetamide (DMAc) was added. Polymerization was performed for 3 hours while controlling the reaction temperature at not more than 90° C. The polymerization solution was diluted with 1400 ml of DMAc, and insolubles were filtered. The filtrate was poured into 10 L of methanol to precipitate the polymer. The precipitated polymer was vacuum dried to give 120 g of a polyarylene. GPC resulted in a number-average molecular weight (Mn) of 39,000 and a weight-average molecular weight (Mw) of 153,000.

A 300-ml three-necked flask equipped with a stirring blade, a thermometer and a nitrogen inlet tube was charged with 120 g of the polyarylene (Mn: 39,000), 970 ml of DMAc, and 29.3 g (338 mmol) of lithium bromide, followed by stirring at 120° C. for 7 hours. The reaction liquid was poured into 5 L of acetone to precipitate the polymer. The polymer was treated with a distilled water/concentrated hydrochloric acid solution (3.0 L/0.37 L) two times. The polymer was washed with distilled water until the pH of the washings became neutral, followed by drying at 70° C. for 12 hours. Consequently, 100 g of a sulfonated polyarylene was obtained. The polymer had an ion exchange capacity of 2.0 meq/g and a weight-average molecular weight (Mw) of 116,000.

### Synthetic Example 3

(1) Synthesis of Hydrophobic Units

A 1-L three-necked flask equipped with a stirrer, a thermometer, a Dean-Stark tube, a nitrogen inlet tube and a cooling tube was charged with 44.5 g (259 mmol) of 2,6-dichlorobenzonitrile, 102.0 g (291 mmol) of 9,9-bis(4-hydroxyphenyl)fluorene, and 52.3 g (379 mmol) of potassium carbonate. The flask was purged with nitrogen, and 366 ml of sulfolane and 183 ml of toluene were added, followed by stirring. The reaction liquid was heated under reflux at 150° C. in an oil bath. Water resulting from the reaction was trapped in the Dean-Stark tube. Water almost ceased to occur after 3 hours, and the toluene was removed outside the system through the Dean-Stark tube. The reaction temperature was slowly raised to 200° C. and stirring was performed for 3 hours. Thereafter, 16.7 g (97 mmol) of 2,6-dichlorobenzonitrile was added to carry out reaction for another 5 hours. The reaction liquid was allowed to cool, and was diluted with 100 ml of toluene. The reaction liquid was filtered to remove insoluble inorganic salts, and the filtrate was poured into 2 L of methanol to precipitate the product. The precipitated product was filtered off, dried and dissolved in 250 ml of tetrahydrofuran. The resultant solution was poured into 2 L of methanol to perform reprecipitation. The precipitated white powder was filtered off and was dried to yield 118 g of an objective compound. GPC resulted in a number-average molecular weight (Mn) of 7,300. The compound was identified to be an oligomer represented by Formula (III) below: 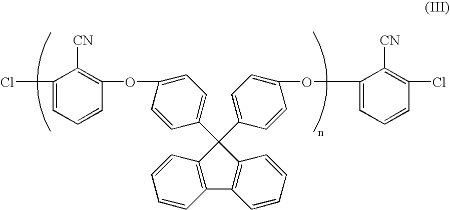
(2) Synthesis of High Water Content Sulfonated Polyarylene

A 1-L three-necked flask equipped with a stirrer, a thermometer and a nitrogen inlet tube was charged with 207.5 g (517 mmol) of neopentyl 3-(2,5-dichlorobenzoyl) benzenesulfonate, 57.5 g (7.88 mmol) of the oligomer (Mn: 7,300) obtained in (1), 10.3 g (15.8 mmol) of bis(triphenylphosphine)nickel dichloride, 2.36 g (15.8 mmol) of sodium iodide, 55.1 g (210 mmol) of triphenylphosphine, and 82.4 g (1260 mmol) of zinc. The flask was purged with dry nitrogen, and 720 ml of N,N-dimethylacetamide (DMAc) was added. The mixture was stirred for 3 hours while maintaining the reaction temperature at 80° C. The reaction liquid was diluted with 1360 ml of DMAc, and insolubles were filtered.

The solution obtained was introduced into a 2-L three-necked flask equipped with a stirrer, a thermometer and a nitrogen inlet tube, and was heated to 115° C. with stirring. Subsequently, 98.8 g (1138 mmol) of lithium bromide was added. After the mixture had been stirred for 7 hours, it was poured into 5 L of aceton to precipitate the product. The product was washed sequentially with 1N hydrochloric acid and with pure water, and was dried to give 223 g of an objective polymer. The weight-average molecular weight (Mw) of the polymer was 142,000. The polymer was assumed to be a sulfonated polymer represented by Formula (IV). The polymer had an ion exchange capacity of 2.4 meq/g. A film of the polymer had a water content of 115%. 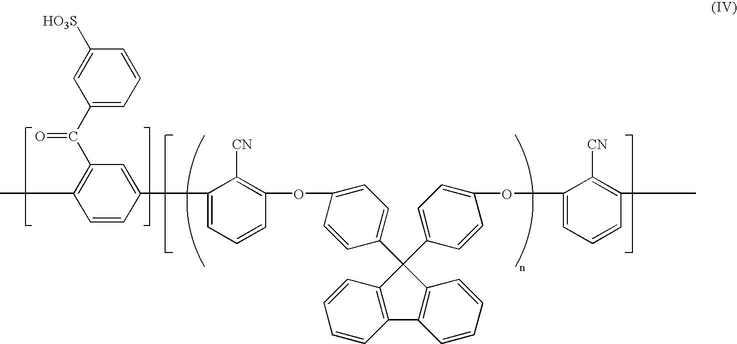
(3) Synthesis of Low Water Content Sulfonated Polyarylene

A 1-L three-necked flask equipped with a stirrer, a thermometer and a nitrogen inlet tube was charged with 152.4 g (380 mmol) of neopentyl 3-(2,5-dichlorobenzoyl) benzenesulfonate, 147.2 g (20.17 mmol) of the oligomer (Mn: 7,300) obtained in (1), 10.5 g (16.1 mmol) of bis(triphenylphosphine)nickel dichloride, 1.80 g (12.1 mmol) of sodium iodide, 42.0 g (160 mmol) of triphenylphosphine, and 62.8 g (960 mmol) of zinc. The flask was purged with dry nitrogen, and 850 ml of N,N-dimethylacetamide (DMAc) was added. The mixture was stirred for 3 hours while maintaining the reaction temperature at 80° C. The reaction liquid was diluted with 1870 ml of DMAc, and insolubles were filtered.

The solution obtained was introduced into a 2-L three-necked flask equipped with a stirrer, a thermometer and a nitrogen inlet tube, and was heated to 115° C. with stirring. Subsequently, 99.0 g (1140 mmol) of lithium bromide was added. After the mixture had been stirred for 7 hours, it was poured into 5 L of aceton to precipitate the product. The product was washed sequentially with 1N hydrochloric acid and with pure water, and was dried to give 223 g of an objective polymer. The weight-average molecular weight (Mw) of the polymer was 145,000. The polymer was assumed to be a sulfonated polymer represented by Formula (IV) above. The polymer had an ion exchange capacity of 1.5 meq/g. A film of the polymer had a water content of 40%.

### Example 3

<Preparation of Anode Paste>

A 50-ml plastic bottle was charged with 25 g of zirconia balls 10 mm in diameter (YTZ balls manufactured by Nikkato Corporation), 1.53 g of platinum-supported carbon particles (manufactured by Tanaka Kikinzoku Kogyo, Pt content: 48 wt %), 0.88 g of distilled water, 12.47 g of NMP, and 4.59 g of a 15 wt % NMP solution of the polymer of Synthetic Example 3 (2). The materials were stirred with a paint shaker for 60 minutes to give an anode paste G.

<Preparation of Cathode Paste>

A 50-ml plastic bottle was charged with 25 g of zirconia balls 10 mm in diameter (YTZ balls manufactured by Nikkato Corporation), 1.53 g of platinum-supported carbon particles (manufactured by Tanaka Kikinzoku Kogyo, Pt content: 48 wt %), 0.88 g of distilled water, 12.47 g of NMP, 0.1 g of vapor grown carbon fiber (VGCF manufactured by Showa Denko K.K.), and 4.59 g of a 15 wt % NMP solution of the polymer of Synthetic Example 3 (3). The materials were stirred with a paint shaker for 60 minutes to give a cathode paste H.

<Production of Electrodes>

The anode paste G was applied to water-repellent carbon paper (manufactured by Toray Industries, Inc.) with a doctor blade, and the coating was dried at 120° C. for 60 minutes to produce an anode G containing 0.2 mg/cm² of platinum. The cathode paste H was applied to water-repellent carbon paper (manufactured by Toray Industries, Inc.) with a doctor blade, and the coating was dried at 120° C. for 60 minutes to produce a cathode H containing 0.5 mg/cm² of platinum.

<Fabrication of Fuel Cell>

An ion exchange resin membrane 50 μm in thickness was prepared from the polymer of Synthetic Example 2. The membrane was sandwiched between the anode G and the cathode H such that the electrode catalyst layers contacted the membrane. The unit was hot pressed at 100 kg/cm² and 160° C. for 15 minutes, and a membrane-electrode assembly was prepared. The membrane-electrode assembly was sandwiched between two titanium collectors, and heaters were provided outside each collector. Consequently, a fuel cell sample having an effective area of 25 cm² was fabricated.

### Comparative Example 3

<Preparation of Anode Paste>

An anode paste I was prepared in the same manner as in Example 3, except using the polymer of Synthetic Example 3 (3).

<Production of Electrode>

An anode I was produced in the same manner as in Example 3, except using the anode paste I.

<Fabrication of Fuel Cell>

A fuel cell sample was fabricated in the same manner as in Example 3, except using the anode I obtained above and the cathode H obtained in Example 3.

### Comparative Example 4

<Preparation of Cathode Paste>

A cathode paste J was prepared in the same manner as in Example 3, except using the polymer of Synthetic Example 3 (2).

<Production of Electrode>

A cathode J was produced in the same manner as in Example 3, except using the cathode paste J.

<Fabrication of Fuel Cell>

A fuel cell sample was fabricated in the same manner as in Example 3, except using the cathode J obtained above and the anode I obtained in Comparative Example 3.

[Evaluation]

Hydrogen and air were supplied at a constant back pressure of 0.2 MPa to the anode and cathode, respectively, of the fuel cell samples of Example 3 and Comparative Examples 3-4, at 80° C. and an anode humidity of 50% RH and a cathode humidity of 50% RH, and at 80° C. and an anode humidity of 100% RH and a cathode humidity of 100% RH. The voltage between the terminals was measured under the above two conditions at current density of 0.1 A/cm² and 1.0 A/cm². The results are shown in Table 2.

TABLE 2

| | | | | Comp. | Comp. |
|---|---|---|---|---|---|
| | | | Ex. 3 | Ex. 3 | Ex. 4 |
| Water | Anode resin layer | | 115 | 40 | 40 |
| content | Cathode resin layer | | 40 | 40 | 115 |
| (wt %) | | | | | |
| Voltage | Low | 0.1 A/cm² | 0.80 | 0.75 | 0.78 |
| between | humidity | 1.0 A/cm² | 0.62 | 0.55 | 0.36 |
| terminals | (50% RH) | | | | |
| (V) | High | 0.1 A/cm² | 0.85 | 0.80 | 0.83 |
| | humidity | 1.0 A/cm² | 0.58 | 0.46 | 0.25 |
| | (100% RH) | | | | |

In Example 3, the anode resin layer surpassed the cathode resin layer in water content. As shown in Table 2, Example 3 resulted in superior performance of the fuel cell to Comparative Examples 3 and 4.

1. A membrane-electrode assembly comprising an ion exchange resin membrane, an anode catalyst layer including catalyst-supported carbon and an ion exchange resin, and a cathode catalyst layer including catalyst-supported carbon and an ion exchange resin,
the anode catalyst layer including a binder component of which the ion exchange capacity is higher than that of a binder component in the cathode catalyst layer, and/or
the anode catalyst layer including an ion exchange resin layer of which the water content is higher than that of an ion exchange resin layer of the cathode catalyst layer.

2. A membrane-electrode assembly comprising an ion exchange resin membrane, an anode catalyst layer including catalyst-supported carbon and an ion exchange resin, and a cathode catalyst layer including catalyst-supported carbon and an ion exchange resin,
the anode catalyst layer including a binder component of which the ion exchange capacity is higher than that of a binder component in the cathode catalyst layer by at least 0.05 meq/g.

3. The membrane-electrode assembly according to claim 2, wherein the ion exchange resin membrane has an ion exchange capacity higher than that of the binder component in the cathode catalyst layer

4. The membrane-electrode assembly according to claim 2, wherein the ion exchange resin membrane has an ion exchange capacity lower than that of the binder component in the anode catalyst layer.

5. The membrane-electrode assembly according to claim 3, wherein the ion exchange resin membrane has an ion exchange capacity lower than that of the binder component in the anode catalyst layer.

6. A membrane-electrode assembly comprising an ion exchange resin membrane, an anode catalyst layer including catalyst-supported carbon and an ion exchange resin, and a cathode catalyst layer including catalyst-supported carbon and an ion exchange resin,
the anode catalyst layer including an ion exchange resin layer of which the water content (wt %) is higher than that of an ion exchange resin layer of the cathode catalyst layer by 5 to 100 wt %.

7. The membrane-electrode assembly according to any one of claims 1 to 6, wherein at least one of the ion exchange resin constituting the ion exchange resin membrane, the ion exchange resin constituting the anode catalyst layer, and the ion exchange resin constituting the cathode catalyst layer is a block copolymer comprising a polymer segment (A) with an ion conductive component composed of a sulfonic acid group or a phosphoric acid group, and a polymer segment (B) without an ion conductive component, the polymer segment (A) and the polymer segment (B) being covalently bound.

8. The membrane-electrode assembly according to any one of claims 1 to 6, wherein at least one of the ion exchange resin constituting the ion exchange resin membrane, the ion exchange resin constituting the anode catalyst layer, and the ion exchange resin constituting the cathode catalyst layer has a main chain skeleton comprising aromatic rings covalently bound together through binding groups.

9. The membrane-electrode assembly according to any one of claims 1 to 6, wherein at least one of the ion exchange resin constituting the ion exchange resin membrane, the ion exchange resin constituting the anode catalyst layer, and the ion exchange resin constituting the cathode catalyst layer is a sulfonated polyarylene comprising a structural unit represented by Formula (A) and a structural unit represented by Formula (B): 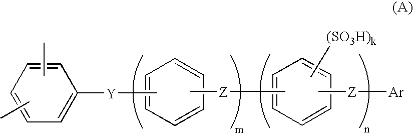
wherein Y is —CO—, —SO₂—, —SO—, —CONH—, —COO—, —(CF₂)ᵢ— (where i is an integer of 1 to 10) or —C(CF₃)₂—;
Z are independently a direct bond, —(CH₂)ⱼ— (where j is an integer of 1 to 10), —C(CH₃)₂—, —O— or —S—;
Ar is an aromatic group having a substituent represented by —SO₃H, —O(CH₂)ₚSO₃H or —O(CF₂)ₚSO₃H (where p is an integer of 1 to 12);
m is an integer of 0 to 10; n is an integer of 0 to 10; and k is an integer of 1 to 4; 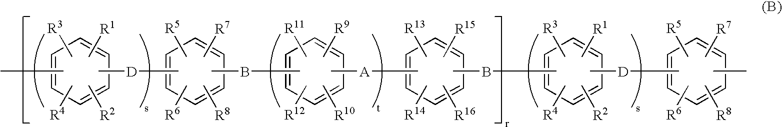
wherein A and D are each a direct bond, —CO—, —SO₂—, —SO—, —CONH—, —COO—, —(CF₂)ᵢ— (where i is an integer of 1 to 10), —(CH₂)ⱼ— (where j is an integer of 1 to 10), —CR′₂— (where R′ is an aliphatic hydrocarbon group, an aromatic hydrocarbon group or a halogenated hydrocarbon group), cyclohexylidene group, fluorenylidene group, —O— or —S—;
B are independently an oxygen atom or a sulfur atom;
R¹ to R¹⁶ are independently each a hydrogen atom, a fluorine atom, an alkyl group, a partially or fully halogenated alkyl group, an allyl group, an aryl group, a nitro group or a nitrile group;
s and t are each an integer of 0 to 4; and r is an integer of 0 or greater.

10. The membrane-electrode assembly according to claim 9, wherein the ion exchange resin constituting the anode catalyst layer and the ion exchange resin constituting the cathode catalyst layer are each a sulfonated polyarylene comprising a structural unit represented by Formula (A) and a structural unit represented by Formula (B).

11. The membrane-electrode assembly according to claim 9, wherein the ion exchange resin constituting the ion exchange resin membrane, the ion exchange resin constituting the anode catalyst layer, and the ion exchange resin constituting the cathode catalyst layer are each a sulfonated polyarylene comprising a structural unit represented by Formula (A) and a structural unit represented by Formula (B).
